(19) United States
(12) Patent Application Publication
(10) Pub. No.: US 2005/0217625 A1
(43) Pub. Date: Oct. 6, 2005

(54) Heat shielded air intake system

(75) Inventors: Shahriar Nick Niaken, Anaheim Hills, CA (US); Saul Daniel Zambrano, Quartz Hill, CA (US); Christopher M. Barron, Riverside, CA (US)

Correspondence Address: SHIMOKAJI & ASSOCIATES, P.C., Suite 480, 1301 Dove Street, Newport Beach, CA, 92660, US

(73) Assignee: Advanced flow engineering, Inc., Corona, CA (US)

(21) Appl. No.: 11/100,260

(22) Filed: Apr. 5, 2005

Related U.S. Application Data
(60) Provisional application No. 60/559,710, filed on Apr. 5, 2004.

(51) Int. Cl. F02M 35/10

(52) U.S. Cl. 123/184.21; 123/198 E

(57) ABSTRACT

An air filter system includes a housing having, for example, a rear panel and a side panel, each having a top edge formed to interface to the hood of a vehicle so that the housing incorporates the vehicle hood to provide thermal isolation of intake air from engine compartment heat. The air filter system connects to a stock air intake tract through an air intake tube. The housing has a diagonal panel that the air intake tube is attached to and passes through. The diagonal panel is disposed at an angle that provides positioning of the air intake tube so that an effluent end of the air intake tube matches the stock location of the stock air intake tract. A washable, reusable air filter supported by the air intake tube filters the intake air and passes it through the air intake tube into the stock air intake tract.

### CROSS-REFERENCE TO RELATED APPLICATIONS

This application claims the benefit of U.S. Provisional Patent Application No. 60/559,710, filed on Apr. 5, 2004.

### BACKGROUND OF THE INVENTION

This invention relates to high performance air intake systems and, in particular, to a high flow air intake system that filters the intake air, such as for use within the 2003 and later model years for Dodge Cummins trucks with a 5.9 Liter turbo diesel engine.

It is well known that efficiency for a thermodynamic system—such as an automobile engine—increases proportionally with the difference in temperature between the system's input and its output. In the case of an automobile engine, for example, the difference between the input and output temperatures can be increased by protecting the intake air from heat, keeping it cooler. At the same time, the intake air for an internal combustion engine usually needs to be filtered without restricting the flow (measured as volume of gas per unit time) of air required by the engine.

The function of an air intake filter is to remove the particulate matter from the intake air, so that clean air is provided to the engine. The intake air stream flows from the influent, or “dirty,” side of the filter to the effluent, or “clean,” side of the filter, with the air filter extracting the unwanted particles via one or more filter media layers. Filter media are selected to trap particles exceeding a particular size, while remaining substantially permeable to airflow over an expected filter lifetime.

The features and filter design choices that lead to improvements in one of these parameters (e.g., particle entrapment, airflow permeability, and filter lifetime) can lead to declines in the other performance parameters. Thus, filter design involves trade-offs among features achieving high filter efficiency, and features achieving a high filter capacity and concomitant long filter lifetime.

Filter efficiency may be described as the propensity of the filter media to trap, rather than pass, particulates. Filter capacity is typically defined according to a selected limiting pressure differential across the filter, typically resulting from loading by trapped particulates. Volumetric filter flow rate, or flow rate, is a measure of the volume of air that can be drawn into the filter having a particular effective filter area, efficiency, and capacity, at a particular point in the expected filter lifetime.

The choice of filter media that has a high filter efficiency (wherein the filter media removes a high percentage of the particulate material in the intake air) is important, because any particulate matter passing through the filter may harm the engine. For systems of equal efficiency, a longer filter lifetime typically is directly associated with higher capacity, because the more efficiently the filter medium removes particles from an air stream, the more rapidly that filter medium approaches the pressure differential indicating the end of the filter medium life. To extend filter lifetime, filter media can be pleated to provide greater filtering surface area.

The choice of air filter media that is permeable to airflow is important because the interposition of the filter into the intake air stream can impede the flow rate. Impeded airflow tends to decrease engine efficiency, horsepower, torque, and fuel economy. In applications demanding large volumes of filtered air, the ability to manipulate parameters such as air filter size, pleat depth, or both, is often constrained additionally by the physical environment in which the filter is operated (e.g., the space available for a filter of a given configuration within the engine compartment).

FIG. 1 shows an existing stock air intake system 100 as installed on a vehicle such as a 2003 Dodge Cummins truck with a 5.9 L turbo diesel engine. Stock air intake system 100 may include an air box 102 that may hold inside it a stock air filter (not shown). The stock air filter is typically a non-reusable unit having a relatively short expected filter lifetime that requires the stock filter to be replaced periodically. Air box 102 may direct filtered air from the air filter via outlet 104 of air box 102 to existing stock air intake tract 106, and may allow entry near the bottom (not shown) of air box 102 of air to be filtered. Air box 102 and outlet 104 may provide mounting points and access to intake air flows or pressures, for example, for various stock sensors and controls, such as temperature sensor 107 or filter minder 109. Temperature sensor 107, for example, may be part of an electronic engine control system. Filter minder 109 may be an electrical or mechanical device that provides an indicator to the vehicle operator that the filter needs to be cleaned or replaced. For example, a mechanical filter minder 109 could be a spring activated pressure device triggered by increased pressure differential across the filter as the filter becomes clogged, switching a mechanical color indicator from green to red. An electronic filter minder 109 could operate similarly, with an electro-mechanical switch or transducer to send an electrical signal, for example, to a dashboard indicator.

Air box 102 may have clamps and mounting fixtures (not shown in FIG. 1) that secure air box 102 at its location within engine compartment 108. Prior art air boxes, such as air box 102, are typically surrounded by various spaces within the engine compartment. For example, there may be a space between left side 110 of air box 102 and internal combustion engine 111; there may be a space between front 112 of air box 102 and the front of engine compartment 108; there may be a space between right side 114 of air box 102 and the right side of engine compartment 108; there may be a space between rear 116 of air box 102 and the rear of engine compartment 108; and there may be a space between top 118 of air box 102 and the top of engine compartment 108 which is usually formed by the hood of the vehicle (not shown). Because the air box 102 may, thus, be completely surrounded by the heated air of the engine compartment 108, air box 102 may not be effective at insulating the intake air from heat. In addition, air box 102 typically fits the air filter so that air box 102 closely surrounds the air filter contained inside. For example, see U.S. Pat. No. 6,319,298. Thus, the effectiveness of air box 102 as a heat shield is lessened by the contact of several surfaces of air box 102 with hot air of the engine compartment 108 and the close proximity of the heated surfaces of air box 102 to the air filter inside air box 102.

As can be seen, there is a need for an air intake system with improved air flow rate that more effectively protects intake air from engine compartment heat to deliver cooler intake air to the engine. Furthermore, there is a need for an air intake system that makes more efficient use of space available within an engine compartment for enabling use of a high volumetric flow rate, high efficiency air filter.

### SUMMARY OF THE INVENTION

In one aspect of the present invention, an air intake system includes a housing interfaced to an engine compartment boundary and an air intake tube connected to a stock air intake tract of an existing air intake system.

In another aspect of the present invention, a heat shield includes a multiple number of panels. Each panel is contiguous with at least one other of the panels to form a housing, and at least one edge of one of the panels interfaces to an engine compartment boundary so that the housing incorporates the engine compartment boundary to form the heat shield.

In a further aspect of the present invention, a vehicle includes: a housing having a plurality of panels. The housing incorporates the panels with at least one engine compartment boundary to form a heat shield. The vehicle also includes an air intake tube passing through the heat shield housing and connected to a stock air intake tract; and an air filter connected to the air intake tube so that intake air passes through the air filter, into the air intake tube, and on into the stock air intake tract.

In still a further aspect of the present invention, an air filter system includes a housing having a rear panel and a side panel. The rear panel and the side panel each have a top edge formed to interface to the hood of a vehicle so that the housing incorporates the vehicle hood to provide thermal isolation of intake air from engine compartment heat. The air filter system also includes an air intake tube connected to a stock air intake tract. The housing has a diagonal panel that the air intake tube is attached to and passes through, and the diagonal panel is disposed at an angle that provides positioning of the air intake tube, which is mounted to the diagonal panel, so that an effluent end of the air intake tube matches a stock location of a stock air intake tract. A washable, reusable air filter is connected to and supported by the air intake tube so that the intake air is filtered through the air filter and passes through the air intake tube into the stock air intake tract.

In yet another aspect of the present invention, a method for delivering air to the intake of a vehicle engine includes operations of: interfacing a housing to boundaries of an engine compartment of a vehicle; shielding intake air from engine compartment heat with the interfaced housing; and passing the shielded intake air from the interfaced housing to a stock air intake tract of the vehicle.

These and other features, aspects and advantages of the present invention will become better understood with reference to the following drawings, description and claims.

### BRIEF DESCRIPTION OF THE DRAWINGS

FIG. 1 is a perspective view from the side of a vehicle of a prior art air intake system;

FIG. 2 is a perspective view from the front of a vehicle of a heat shielded air intake system in accordance with an embodiment of the present invention;

FIG. 3 is a perspective view from the side of a vehicle of a heat shielded air intake system in accordance with an embodiment of the present invention;

FIG. 4 is a perspective view from the inside of a heat shielded air intake system in accordance with an embodiment of the present invention;

FIG. 5 is a perspective view from the outside of a heat shielded air intake system in accordance with an embodiment of the present invention;

FIG. 6A is an isometric view of a heat shielded air intake system support structure in accordance with one embodiment of the present invention;

FIGS. 6B through 6D are orthographic views of a heat shielded air intake system support structure in accordance with one embodiment of the present invention;

FIG. 6E is an orthographic view of a ventilated floor panel of a heat shielded air intake system support structure in accordance with one embodiment of the present invention;

FIG. 6F is an isometric view of a mounting bracket for a heat shielded air intake system support structure in accordance with one embodiment of the present invention; and

FIG. 7 is a flow chart of a method of providing intake air to an internal combustion engine in accordance with an embodiment of the present invention.

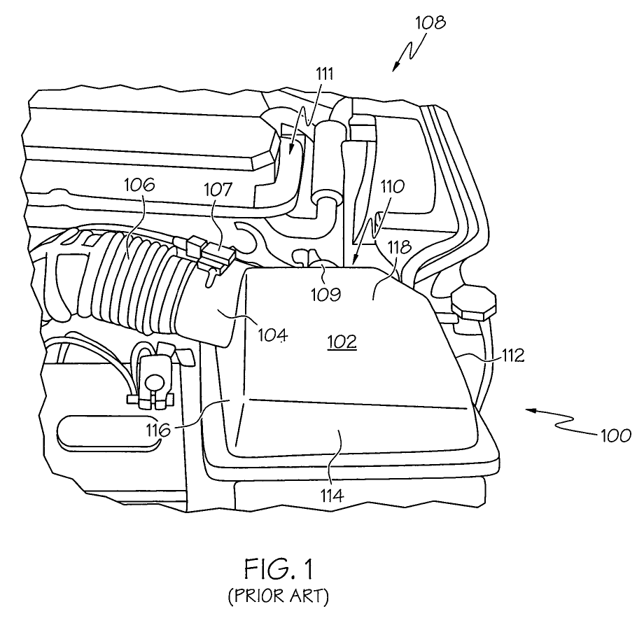

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides air intake and filtering for an internal combustion engine, such as found in automotive vehicles and, in particular, 2003 and later model years for Dodge Cummins trucks with a 5.9 Liter (L) turbo diesel engine. An embodiment of the present invention may be used to replace the existing, i.e., stock, or original equipment manufacturer (OEM), air filter and air box with a washable, reusable air filter, heat shield housing to protect the air filter from engine heat, and air intake tube connecting to the existing stock air intake tract that allow more airflow into the engine and isolate the reusable filter and intake air from engine heat. A washable, reusable air filter, for example, is disclosed in U.S. Pat. No. 6,811,588, which is incorporated by reference. In addition, it is known in the art to use a washable, reusable filter comprising, for example, four layers of cotton gauze. One embodiment may be configured to be installed in the stock air filter location within a stock engine compartment of a 2003 and later model year Dodge Cummins truck with a 5.9 Liter (L) turbo diesel engine without the use of additional pieces to maintain the stock look, including the color of the heat shield housing, and to fit without further modification to stock equipment beyond removing the stock air box, disconnecting sensors from the stock air box and reconnecting those sensors to the replacement air intake and filtering system.

An embodiment of the present invention may be distinguished from the prior art in its overall configuration in which the heat shield interfaces to sides and top (vehicle hood) of the engine compartment to effectively incorporate portions of the engine compartment boundaries as part of the heat shield housing. By thus making more efficient use of engine compartment volume available for use by the air intake system, the heat shield housing surfaces can enclose a larger volume for the reusable air filter to reside in. The larger volume increases the effectiveness of the heat shield by enabling the heat shield housing of one embodiment to not so closely surround the air filter as typical with prior art heat shields. In effect, the larger volume enclosing the air filter provides greater space between the air filter and heat shield so that the heat shield is more effective at keeping heat away from the air filter and intake air flow. In addition, by using engine compartment boundaries for some of the heat shield surfaces, e.g. the front, right side (right fender), and top (hood), the outside of those heat shield surfaces are in contact with cooler outside air rather than heated engine compartment air, unlike prior art air box 102, for example, for which the outside of front 112, right side 114, and top 118 of air box 102 are in contact with the heated air of engine compartment 108.

In addition, the larger available volume gained through more efficient use of engine compartment space—for example, the engine compartment no longer contains an air box top, air box front, and air box right side along with wasted space between these and the corresponding engine compartment sides—allows for a larger and better breathing air filter having less restriction to flow than an air filter the smaller prior art air boxes are capable of using. The larger volume effectively provides a greater air opening for flow of air to the air filter and enables an air filter that can “breath” through a greater influent surface area—e.g., the entire outside of the frusto-conical shape air filter of one embodiment—to be used rather than the typical prior art rectangular slab type filter or “flow-through” type filter having comparatively small influent surface area. For example, the stock air intake and filter for a 2003 model year Dodge Cummins truck with a 5.9 Liter (L) turbo diesel engine typically delivers 229 cubic feet per minute (cfm) at 1.5 inches water column (H₂O) pressure difference, while the air intake and filter for a 2003 model year Dodge Cummins truck with a 5.9 Liter (L) turbo diesel engine in accordance with one embodiment delivers 297 cfm at 1.5 inches H₂O.

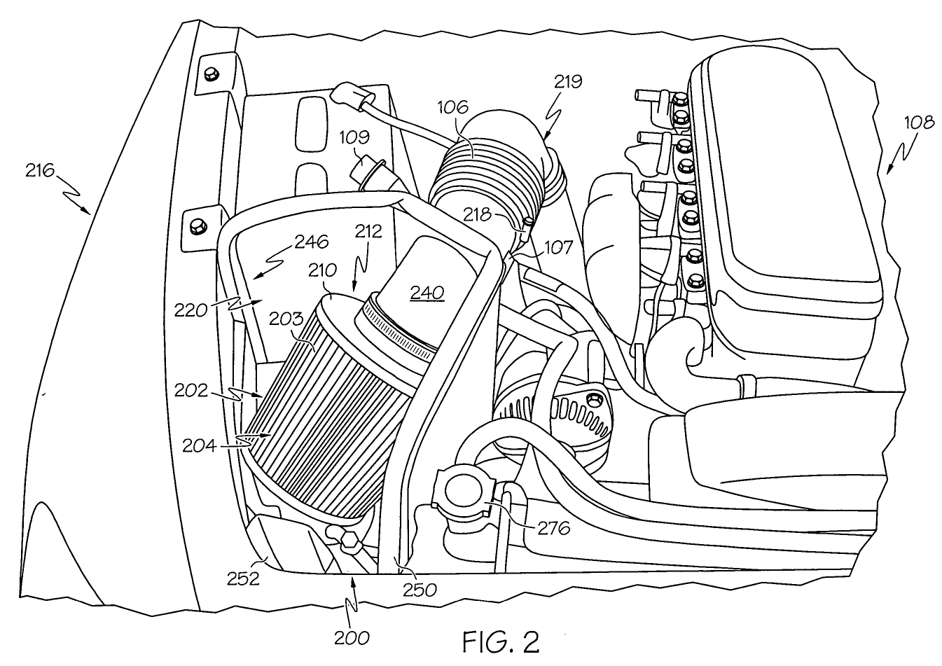

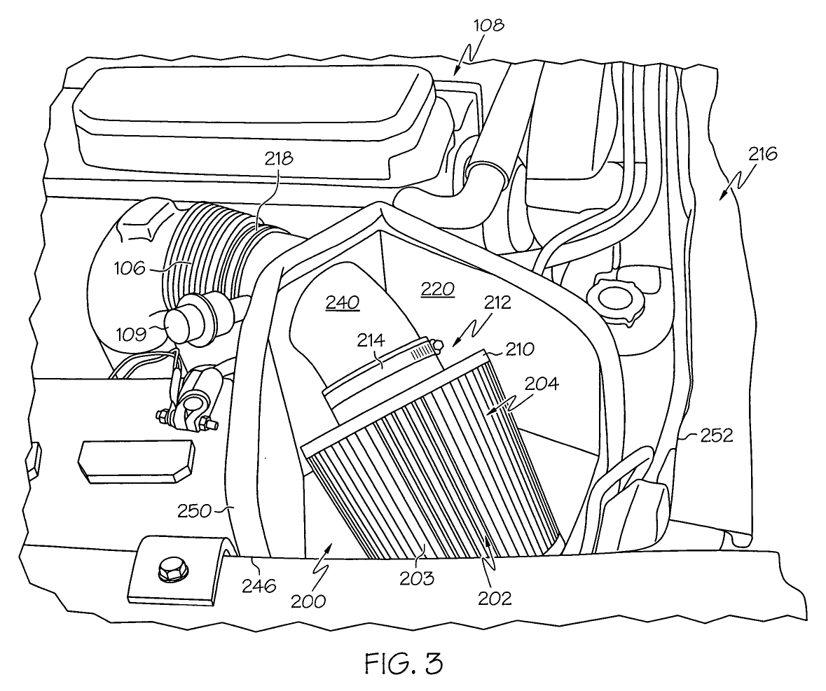

Referring now to the figures and, in particular, to FIGS. 2 and 3, an air intake system 200 is shown according to one embodiment of the present invention. Air intake system 200 may include a washable, reusable air filter 202, a housing 220, and an air intake tube 240.

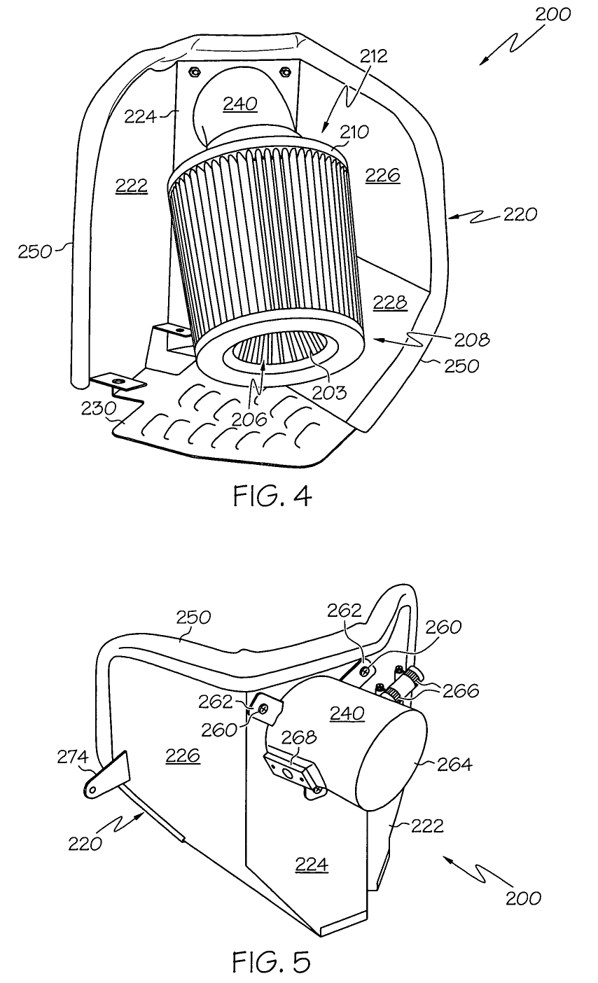

Air filter 202 may have a generally cylindrical shape, for example, that is either tapered or straight (untapered) with either a circular cross section or some other cross section, such as an oval cross section. As shown in the figures, air filter 202 may have tapered cylindrical shape with circular cross section, which may also generally be referred to as a “frusto-conical” shape. The generally cylindrical shape of air filter 202 may provide a large influent surface area 204 in comparison to the volume occupied by air filter 202, thus providing increased breathing efficiency over other forms of air filter. Air filter 202 may include filter media 203, and may be a washable, reusable air filter such as disclosed in U.S. Pat. No. 6,811,588, or a filter comprising, for example, four layers of cotton gauze, as known in the art. Filter media 203 may be pleated as shown to increase the influent surface area 204. Air filter 202 may include additional influent surface area 206, for example, at an external end 208 of air filter 202, as shown in FIG. 4. Air filter 202 may have a seal 210 at an effluent end 212 of filter 202. Seal 210 may be formed, for example, from urethane or polyurethane. Air filter 202 may be attached to air intake tube 240, for example, using a clamp 214 to hold seal 210 firmly to air intake tube 240 to provide a fluid seal so that intake air may pass through influent surface area 204 of filter 202, be filtered by filter media 203, pass into air intake tube 240 without leaking at seal 210, and continue into stock air intake tract 106 of vehicle 216, which may be a truck with a diesel engine, for example, a Dodge Cummins truck with a 5.9 Liter (L) turbo diesel engine for 2003 and later model years. Air intake tube 240 may be similarly sealed to stock air intake tract 106 using a stock fixture—such as clamp 218—so that intake air passes from air intake tube 240 to stock air intake tract 106 without leaking. In an alternative configuration, stock air intake tract 106 may be replaced by a tube that connects between air intake tube 240 (e.g., at clamp 218) and a stock connection 219, for example, to a turbo charger of vehicle 216 (as shown in FIG. 2), a throttle body, a carburetor, or other air inlet to the engine of vehicle 216.

Housing 220 may perform a number of functions. For example, housing 220 may provide a heat shield that isolates air filter 202 and intake air from the hot conditions of engine compartment 108. Housing 220 may provide support for air filter 202, for example, by supporting air intake tube 240, which in turn supports air filter 202. Housing 220 may be configured to be securely attached to vehicle 216—providing support for air filter 202 and effective heat shield interfacing with various boundaries of engine compartment 108, for example—using stock mounting locations and fixtures of vehicle 216. Housing 220 also may be configured to fit within the stock location vacated by a stock air box—such as stock air box 102. By “stock location” (e.g., “stock air box location”) is meant that no significant further modifications—such as moving components, e.g., an alternator, radiator, or battery, or drilling additional holes—may be required to the location (e.g., once the stock air box 102 is removed). Housing 220 may be fabricated using metal—such as cold rolled steel, stainless steel, or aluminum—and painted, powder coated, or anodized, for example. Also, for example, housing 220 may be fabricated using plastic.

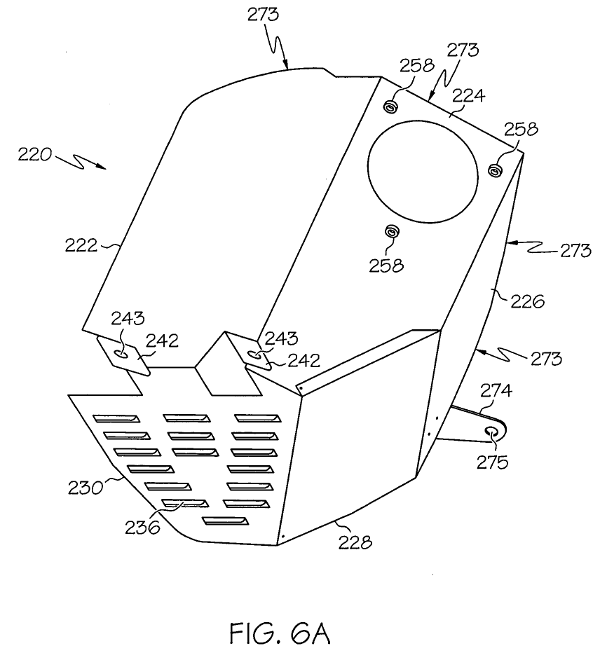

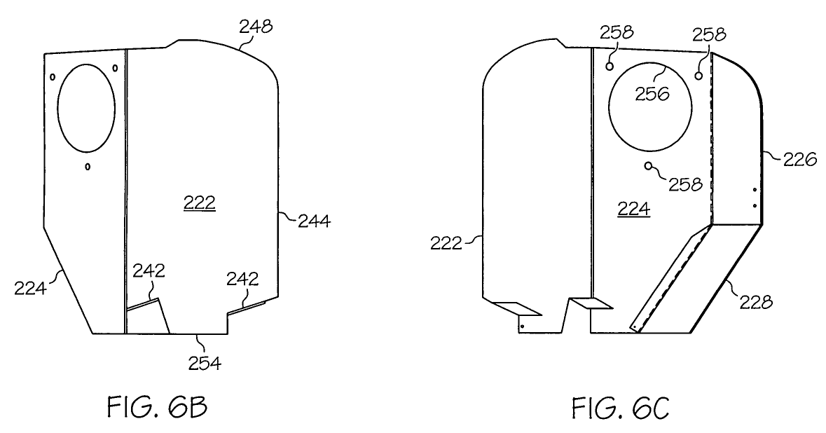

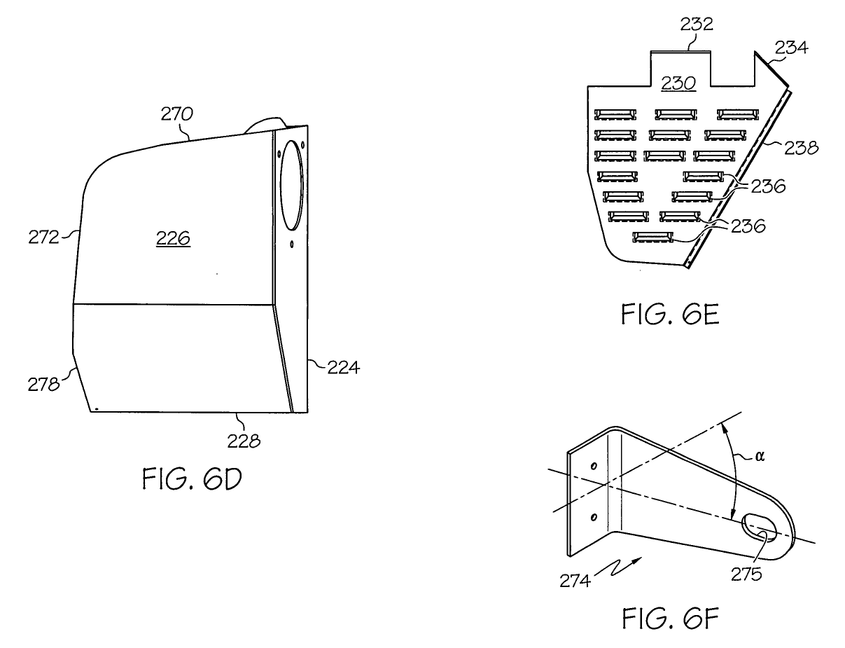

Housing 220 may include a rear panel 222, a diagonal panel 224, a side panel 226, a canted panel 228, and a floor panel 230, as shown in FIGS. 4, 5, and 6A through 6E. The rear panel 222, diagonal panel 224, side panel 226, canted panel 228, and floor panel 230 may be contiguous with each other, as most clearly shown in FIGS. 4 and 6A. Housing 220 may be formed, for example, from a single piece of sheet metal. In the example used to illustrate one embodiment, housing 220 may be formed from two pieces of sheet metal: one for floor panel 230 and one for the remaining panels. Thus, the rear panel 222, diagonal panel 224, side panel 226, and canted panel 228 of housing 220 may be formed from a single piece of sheet metal cut to an appropriate pattern—as illustrated by FIGS. 6B through 6E—and folded at appropriate angles along appropriate lines—also as illustrated by FIGS. 6B through 6E. In the example used to illustrate one embodiment, floor panel 230 (see FIG. 6E) may be provided with tabs for welding or otherwise bonding floor panel 230 to the other panels contiguous with floor panel 230—such as tab 232 for bonding floor panel 230 to rear panel 222; tab 234 for bonding to diagonal panel 224, and tab 238 for bonding to canted panel 228.

The particular shape, angling, positioning, and other specific features of the housing panels may perform various functions, for example, to match a stock location for mounting or fitting housing 220 or to clear a stock component already present and remaining in the vehicle 216, which may be, for example, a Dodge Cummins truck for 2003 and later model years. For example, floor panel 230 may include a number of louvers 236 (see FIG. 6E). Louvers 236 may increase the volume of flow of intake air to air filter 202. Louvers 236 may provide stiffness to floor panel 230 to support canted sidewall 228 and increase the stiffness for the structure of housing 220.

Rear panel 222 may include mounting tabs 242 (see FIG. 6A) with mounting holes 243 positioned to match stock mounting hole or bolt locations on vehicle 216. As more clearly seen in FIG. 6B, mounting tabs 242 may be placed at an angle to provide a better fit to a stock mounting location and to provide for a better interface between edges of rear panel 222 and boundaries of engine compartment 108. For example, side edge 244 may interface with side 246 of engine compartment 108 (see FIGS. 2 and 3). By “interface” it is meant, as above, that the edges of housing 220 fit closely enough to the boundaries (e.g., sides, front, top or hood) of the engine compartment to effectively incorporate portions of the engine compartment boundaries as part of the heat shield function (e.g. thermal isolation of intake air from engine compartment heat) of housing 220. Also, for example, top edge 248 of rear panel 222 may be shaped as shown to interface with top (e.g., the hood of vehicle 216) of engine compartment 108. Top edge 248 and side edge 244 of rear panel 222—as well as other edges of housing 220—may be covered with a trim seal 250 as shown in FIGS. 2 through 5. Trim seal 250 may be a soft rubberized type material, like foam but hollow, and may have a round cross section, with a U-shaped piece attached to trim seal 250, and the U-shaped piece goes over the housing 220 (heat shield) edges—such as edges 244 and 248. Trim seal 250 may, for example, improve the effectives of the heat shield interface of housing 220 with engine compartment 108, for example, by sealing against the side 246 and front 252 of engine compartment 108, and top (hood) of vehicle 216. Trim seal 250 may also, for example, provide protection to vehicle users and operators from exposed metal edges of housing 220, as well as protecting the metal edges themselves, and may also contribute to a “finished look” or aesthetics of air intake system 200.

Rear panel 222 may have a bottom edge 254 that is lower than the location of mounting tabs 242 (see FIG. 6B). The mounting tabs 242 may match to specific factory, i.e., stock, mounting points. Vehicle 216 may, however, have open space available below the specific factory mounting points, and by placing bottom edge 254 lower, floor 230, which joins rear panel 222 at edge 254 may be lower, increasing the volume enclosed by housing 220 and occupied by air filter 202, allowing use of a larger air filter 202, and making more efficient use of available space in engine compartment 108 than can be achieved by prior art approaches that closely surround an air filter with a heat shield or place the air filter in an air box such as stock air box 102.

Diagonal panel 224 may have a hole 256 (see FIG. 6C) that may allow air intake tube 240 to pass through diagonal panel 224 and may also allow diagonal panel 224 to support air intake tube 240. PEM® nuts may be affixed to diagonal panel 224 at fastener locations 258 to provide means to securely fasten air intake tube 240 to diagonal panel 224. For example, bolts 260 (see FIG. 5) may be passed through mounting tabs 262 on air intake tube 240 and threaded into PEM® nuts, for example, or conventional nuts, at fastener locations 258 to attach air intake tube 240 to diagonal panel 224. Thus, diagonal panel 224 may support air intake tube 240 and provide positioning of air intake tube 240 so that effluent end 264 of air intake tube 240 matches the stock location of stock air intake tract 106. In an alternative configuration, air intake tube 240 may be made longer so that effluent end 264 of air intake tube 240 matches the stock location of stock connection 219 to some other air inlet of the vehicle 216 engine—such as a throttle body, carburetor or a turbo charger as shown in FIG. 2—so that stock air intake tract 106 may be replaced by the longer alternative configuration of tube 240. Diagonal panel 224 may be disposed at an angle as shown so that diagonal panel 224 may be perpendicular to a longitudinal axis of air intake tube 240 as it enters housing 220 so that the angle and flow of air intake tube 240 at effluent end 264 can match that of stock air intake tract 106 (or in the alternative configurations, the tube replacing stock air intake tract 106, or the stock connection 219 to an engine air inlet such as a turbo charger) and yet provide a simple mechanical attachment (e.g., bolts 260 and mounting tabs 262) to housing 220. Because air intake tube 240 may be supported by housing 220, air intake tube 240 may provide support for air filter 202 so that air filter 202 may be mounted to vehicle 216 by simply attaching air filter 202 to air intake tube 240, e.g., using clamp 214. Air intake tube 240 may also have an accommodation 266 (see FIG. 5) for a filter minder device—such as filter minder 109—and a mounting pad 268 for other connection to the vehicle's 216 ignition or throttle systems—such as temperature sensor 107. Air intake tube 240 (as well as the alternative longer configuration of air intake tube 240 that may replace stock air intake tract 106 or the alternative configuration tube to replace stock air intake tract 106) may be fabricated using metal—such as cold rolled steel, stainless steel, or aluminum—and painted, powder coated, or anodized, for example. Also, for example, air intake tube 240 (in short or long configuration or stock air intake tract 106 replacement tube) may be fabricated using plastic.

Side panel 226 may have a top edge 270 (see FIG. 6D) that may be shaped as shown, for example, to interface with top (e.g., the hood of vehicle 216) of engine compartment 108. Top edge 270 of side panel 226 and front edge 272 of side panel 226 also may be covered with trim seal 250. Thus, the entire exposed edge 273 (see FIG. 6A) of housing 220 may be covered with trim seal 250—as shown in FIGS. 2 through 5—to help improve the thermal interface of housing 220 to vehicle 216. A support bracket 274 (see FIGS. 5, 6A, and 6F) may be attached to side panel 226 so that a mounting hole 275 matches a stock location for a bolt that can be used to secure support bracket 274 to vehicle 216, providing additional support for housing 220. Support bracket 274 may be formed to project at an angle a (see FIG. 6F) from side panel 226 so that mounting hole 275 fits squarely to the stock bolt location. Angle α may be 75 degrees, for example, for a 2003 or later model year Dodge Cummins truck with a 5.9 L turbo diesel engine.

Canted panel 228 may be disposed at an angle as shown to provide clearance for stock components—such as radiator 276 (see FIG. 2)—while providing adequate enclosure space for air filter 202 within housing 220. Canted panel 228 may have a front edge 278 (see FIG. 6D) that may be shaped with an angle as shown, for example, to interface with front 252 of engine compartment 108 of vehicle 216. Front edge 278 of canted panel 228 also may be covered with trim seal 250 as shown in FIGS. 2 through 5 to help improve the thermal interface of housing 220 to vehicle 216.

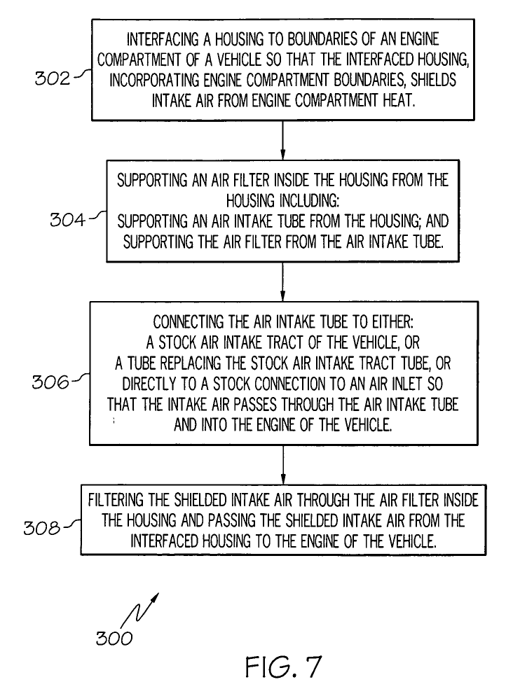

FIG. 7 illustrates a method 300, in accordance with one embodiment, for providing filtered, heat shielded intake air to an internal combustion engine of a motor vehicle—such as a 2003 or later model year Dodge Cummins truck having a 5.9 L turbo diesel engine. At step 302, a housing—such as housing 220—interfaces to the boundaries of an engine compartment of a vehicle so that the interfaced housing incorporates engine compartment boundaries into a heat shield that shields intake air from the engine compartment heat. For example, housing 220 may include panels, e.g. rear panel 222, diagonal panel 224 and side panel 226, that are formed so that their edges closely conform to the sides, top (hood), and front of engine compartment 108 of vehicle 216, which for example, may be a Dodge Cummins truck with a 5.9 L turbo-diesel engine for 2003 and later model years. The interface may be improved by sealing the edges of the housing 220 to the engine compartment 108 boundaries with a trim seal—such as trim seal 250. The housing 220 may also be formed to fit and be mounted at a stock air box location—such as that provided by the removal of stock air box 102.

At step 304, the housing—such as housing 220—supports an air filter inside the housing from the housing. For example, housing 220 may support air intake tube 240 via the attachment of air intake tube 240 to diagonal panel 224 of housing 220, and air intake tube 240 may in turn support air filter 202 via being inserted into air filter seal 210 at effluent end 212 of air filter 202. Support may be enhanced or provided by the clamp 214 used to seal air filter 202 to air intake tube 240.

At step 306, an air intake tube—such as air intake tube 240—connects to the stock air intake tract 106 of the vehicle 216 so that the intake air passes through the air intake tube 240, into the stock air intake tract 106, and into the engine of vehicle 216. Alternatively, at step 306, an air intake tube—such as air intake tube 240—may be connected to a tube that replaces stock air intake tract 106 and connects to a stock connection 219 to an air inlet—such as a throttle body, carburetor, or turbo charger—of vehicle 216. Also, alternatively, at step 306, an air intake tube—such as the longer alternative configuration of air intake tube 240—may be connected directly to a stock connection 219 to an air inlet to the engine of vehicle 216, so that stock air intake tract 106 is replaced.

At step 308, the air filter, which may be a washable, reusable air filter 202, filters the shielded intake air through the air filter 202 inside the housing 220 and passes the shielded intake air from the interfaced housing 220 through the air intake tube 240 to the engine of vehicle 216.

The foregoing relates to exemplary embodiments of the invention. Modifications may be made without departing from the spirit and scope of the invention as set forth in the following claims.

1. An air intake system comprising:
a housing interfaced to an engine compartment boundary; and
an air intake tube connected to a stock air intake tract.

2. The air intake system of claim 1, further comprising:
an air filter inside the housing and connected to the air intake tube.

3. The air intake system of claim 1, further comprising:
a hole in the housing through which the air intake tube passes, wherein the air intake tube is attached to the housing.

4. The air intake system of claim 1, further comprising:
an air filter connected to the air intake tube, wherein
the air intake tube is attached to the housing and supports the air filter.

5. The air intake system of claim 1, wherein:
the housing is supported at a stock mounting location; and
the housing supports the air intake tube.

6. The air intake system of claim 1, further comprising:
a trim seal affixed to an edge of the housing, wherein the trim seal interfaces the housing to the engine compartment boundary.

7. The air intake system of claim 1, wherein:
the housing is mounted to a vehicle within a stock air box location.

8. The air intake system of claim 1, further comprising:
a washable, reusable air filter connected to the air intake tube inside the housing.

9. The air intake system of claim 1, wherein:
said air intake tube is connected to a stock connection to an air inlet.

10. The air intake system of claim 1, further comprising:
a stock air intake tract replacement tube wherein:
said stock air intake tract replacement tube is connected to a stock connection to an air inlet; and
said air intake tube is connected to said stock air intake tract replacement tube.

11. A heat shield comprising:
a plurality of panels, wherein:
each panel is contiguous with at least one other of the plurality of panels to form a housing; and
at least one edge of one of the panels interfaces to an engine compartment boundary so that the housing incorporates the engine compartment boundary to form the heat shield.

12. The heat shield of claim 11, further comprising:
a trim seal covering the at least one edge of one of the panels and sealing the housing to the engine compartment boundary.

13. The heat shield of claim 11, further comprising:
a rear panel having a top edge shaped to interface to a top engine compartment boundary, wherein the top engine compartment boundary is the hood of a vehicle.

14. The heat shield of claim 11, further comprising:
a side panel having a top edge shaped to interface to a top engine compartment boundary, wherein the top engine compartment boundary is the hood of a vehicle.

15. The heat shield of claim 11, further comprising:
a diagonal panel disposed at an angle that provides positioning of air intake tube mounted to the diagonal panel so that an effluent end of the air intake tube matches a stock location of a stock air intake tract.

16. A vehicle comprising:
a housing having a plurality of panels, wherein the housing incorporates the panels with at least one engine compartment boundary to form a heat shield;
an air intake tube passing through the heat shield housing and connected to a stock air intake tract; and
an air filter connected to the air intake tube so that intake air passes through the air filter, into the air intake tube, and on into the stock air intake tract.

17. The vehicle of claim 16, wherein the filter is a washable, reusable filter.

18. The vehicle of claim 16, wherein:
the housing mounts to the vehicle in a stock air box location;
the housing supports the air intake tube; and
the air intake tube supports the air filter.

19. The vehicle of claim 16, wherein:
said air intake tube is directly connected to a stock connection to an air inlet of the vehicle.

20. The vehicle of claim 16, further comprising:
a stock air intake tract replacement tube wherein:
said stock air intake tract replacement tube is connected to a stock connection to an air inlet of the engine of the vehicle; and
said air intake tube is connected to said stock air intake tract replacement tube.

21. An air filter system comprising:
a housing having a rear panel and a side panel, the rear panel and the side panel each having a top edge formed to interface to the hood of a vehicle so that the housing incorporates the vehicle hood to provide thermal isolation of intake air from engine compartment heat;
an air intake tube connected to a stock air intake tract, wherein:
the housing has a diagonal panel that the air intake tube is attached to and passes through, the diagonal panel is disposed at an angle that provides positioning of the air intake tube mounted to the diagonal panel so that an effluent end of the air intake tube matches a stock location of a stock air intake tract; and
a washable, reusable air filter connected to and supported by the air intake tube so that the intake air is filtered through the air filter and passes through the air intake tube into the stock air intake tract.

22. The air filter system of claim 21, wherein:
said air intake tube is connected to a stock connection to an air inlet of the engine of the vehicle.

23. The air filter system of claim 21, further comprising:
a stock air intake tract replacement tube wherein:
said stock air intake tract replacement tube is connected to a stock connection to an air inlet of the engine of the vehicle; and
said air intake tube is connected to said stock air intake tract replacement tube.

24. A method for delivering air to the intake of a vehicle engine, comprising operations of:
interfacing a housing to boundaries of an engine compartment of a vehicle;
shielding intake air from engine compartment heat with the interfaced housing; and
passing the shielded intake air from the interfaced housing to the intake of the vehicle engine.

25. The method of claim 24 further comprising the operation of:
filtering the intake air through an air filter inside the housing before the passing operation.

26. The method of claim 24 further comprising the operations of:
supporting an air intake tube from the housing; and
connecting the air intake tube to a stock air intake tract.

27. The method of claim 24, further comprising the operations of:
supporting an air intake tube from the housing; and
connecting the air intake tube to a stock connection to an air inlet of the vehicle engine.

28. The method of claim 24, further comprising:
replacing a stock air intake tract with a stock air intake tract replacement tube;
connecting said stock air intake tract replacement tube to a stock connection to an air inlet of the vehicle engine; and
connecting said air intake tube to said stock air intake tract replacement tube.

29. The method of claim 24 further comprising the operation of:
supporting an air filter inside the housing from the housing.

30. The method of claim 24 further comprising the operations of:
supporting an air intake tube from the housing;
supporting an air filter inside the housing from the air intake tube;
connecting the air intake tube to a stock air intake tract; and
passing the intake air through the air filter, through the air intake tube, and into the stock air intake tract.

31. The method of claim 24 further comprising the operations of:
supporting an air intake tube from the housing;
supporting an air filter inside the housing from the air intake tube;
connecting the air intake tube to a stock connection to a turbo charger of the vehicle engine; and
passing the intake air through the air filter, through the air intake tube, and into the turbo charger.

32. The method of claim 24 further comprising the operations of:
supporting an air intake tube from the housing;
supporting an air filter inside the housing from the air intake tube;
replacing said stock air intake tract with a stock air intake tract replacement tube;
connecting said stock air intake tract replacement tube to a stock connection to a turbo charger of the vehicle engine; and
connecting said air intake tube to said stock air intake tract replacement tube; and
passing the intake air through the air filter, through the air intake tube, through the stock air intake tract replacement tube, and into the turbo charger.

33. The method of claim 24 wherein the operation of interfacing further comprises:
sealing the edges of the housing to the engine compartment boundaries with a trim seal.

34. The method of claim 24 wherein the operation of interfacing further comprises:
locating the housing in a stock air box location.

35. The method of claim 25 further comprising the operation of:
washing and reusing the air filter.
